(19) United States
(12) Patent Application Publication
(10) Pub. No.: US 2004/0068720 A1
(43) Pub. Date: Apr. 8, 2004

(54) Dynamic instrumentation of an executable program

(76) Inventor: Robert Hundt, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/263,151

(22) Filed: Oct. 2, 2002

(51) Int. Cl. G06F 9/45

(52) U.S. Cl. 717/158; 717/130; 717/131; 717/141

(57) ABSTRACT

Computer-implemented methods for dynamic instrumentation of an application program are provided. One such computer-implemented method includes creating substitute functions corresponding to the original functions in the application program, executing the substitute functions in lieu of the original functions in the application program, and determining the number of indirect calls made to the respective entry points of the original functions. Systems and other methods also are provided.

### BACKGROUND

Analysis of binary executable programs can be performed for various reasons, such as to analyze program performance, verify correctness, and test correct runtime operation. Some analyses are performed prior to runtime (static analysis), while other analyses are performed during runtime (dynamic analysis). For both static and dynamic analysis, however, the analyses are often performed at the function level.

The term “function,” refers to named sections of code that are callable in the source program and encompasses routines, procedures, methods and other similar constructs known to those skilled in the art. The functions in the source code are compiled into segments of executable code. For convenience, the segments of executable code that correspond to the functions in the source code are also referred to as “functions.”

A function is a set of instructions beginning at an entry point and ending at an endpoint. The entry point is the address at which execution of the function begins as the target of a branch instruction. The endpoint is the instruction of the function from which control is returned to the point in the program at which the function was initiated. For a function having multiple entry points and/or multiple endpoints, the first entry point and the last endpoint define the function.

One category of analysis performed on executable programs is “instrumentation.” Instrumentation is generally used to gather runtime characteristics of a program, such as the number of times that a function is executed while the application is executing. “Dynamic instrumentation” is the process of modifying the instructions of an application while the application executes.

Dynamic instrumentation has been used to determine the number of times that a function is called during execution of an application. Information regarding the number of times that the function is called can be used to optimize the application. However, the ability to determine whether the calls to the function are direct or indirect does not exist.

### SUMMARY

An embodiment of a computer-implemented method for dynamic instrumentation of an application program includes creating substitute functions corresponding to the original functions in the application program, executing the substitute functions in lieu of the original functions in the application program, and determining the number of indirect calls made to the respective entry points of the original functions.

An embodiment of a dynamic instrumentation system for performing dynamic instrumentation of an application program includes logic configured to create substitute functions corresponding to the original functions in the application program, logic configured to execute the substitute functions in lieu of the original functions in the application program, and logic configured to determine the number of indirect calls made to the respective entry points of the original functions.

Another embodiment of a dynamic instrumentation system for performing dynamic instrumentation of an application program includes means for creating substitute functions corresponding to the original functions in the application program, means for executing the substitute functions in lieu of the original functions in the application program, and means for determining the number of indirect calls made to the respective entry points of the original functions.

### BRIEF DESCRIPTION OF THE DRAWINGS

FIG. 1 is a schematic diagram depicting an embodiment of a dynamic instrumentation system in accordance with one embodiment of the invention.

FIG. 2 is a flowchart of a process for performing dynamic instrumentation in accordance with one embodiment of the invention.

FIG. 3A is a flowchart of a process for allocating shared memory for the instrumentation process and the application executable.

FIGS. 3B-3D illustrate a sequence of memory states resulting from the process of allocating the shared memory.

FIG. 4 is a block diagram that illustrates the functional layout of memory of an executable application which has a function entry point patched with a breakpoint.

FIG. 5 is a block diagram that illustrates the functional layout of memory of an executable application after an instrumented version of a function has been created.

FIG. 6 is a flow diagram that illustrates the interaction between a process that controls dynamic instrumentation, an executable application and an instrumented function.

FIG. 7 is a schematic diagram depicting an original function and a corresponding instrumented function created by an embodiment of a dynamic instrumentation system in accordance with the invention.

FIG. 8A is a schematic diagram depicting indirect and direct calls arriving at the original function of FIG. 7 prior to instrumentation.

FIG. 8B is a schematic diagram depicting direct calls arriving at the instrumented function and indirect calls arriving at the original function of FIG. 7 after instrumentation.

FIG. 9 is a flowchart of a process for determining the call type of calls targeting a function in accordance with one embodiment of the invention.

### DETAILED DESCRIPTION

Dynamic instrumentation enables instrumentation data for an executable program (also, “executable application” or “application”) to be obtained while the application is executing. This is typically accomplished without any pre-processing, e.g., recompilation or relinking, of the application prior to execution. A system is described herein, which performs dynamic instrumentation of an application for determining whether calls made to functions of the application are direct calls or indirect calls. A “direct call” is a call to a known address, and thus a compiler linker can generate a direct call assembler instruction, whereas an “indirect call” is a call to an address which is not known at compile time. A hybrid form of call, namely an indirect call to a known target, also is considered an indirect call since direct call instructions are not used.

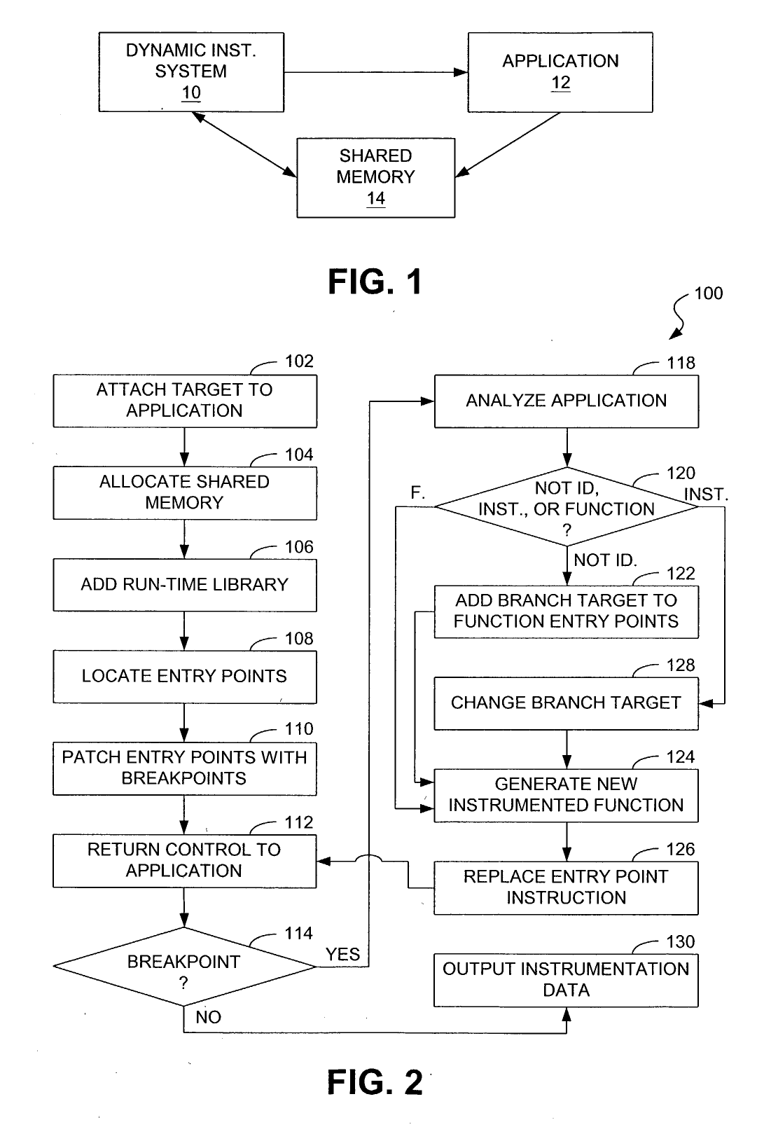

A dynamic instrumentation system 10 in accordance with one embodiment of the invention is depicted schematically in FIG. 1. As shown in FIG. 1, dynamic instrumentation system 10 communicates with an application 12 so that dynamic instrumentation can be performed. In particular, dynamic instrumentation system 10 creates instrumented versions of functions of application 12 when the functions are invoked, and thereafter executes the instrumented functions instead of the original functions. In order to perform dynamic instrumentation, both the dynamic instrumentation system 10 and the application 12 communicate with shared memory 14, as will be described in detail later.

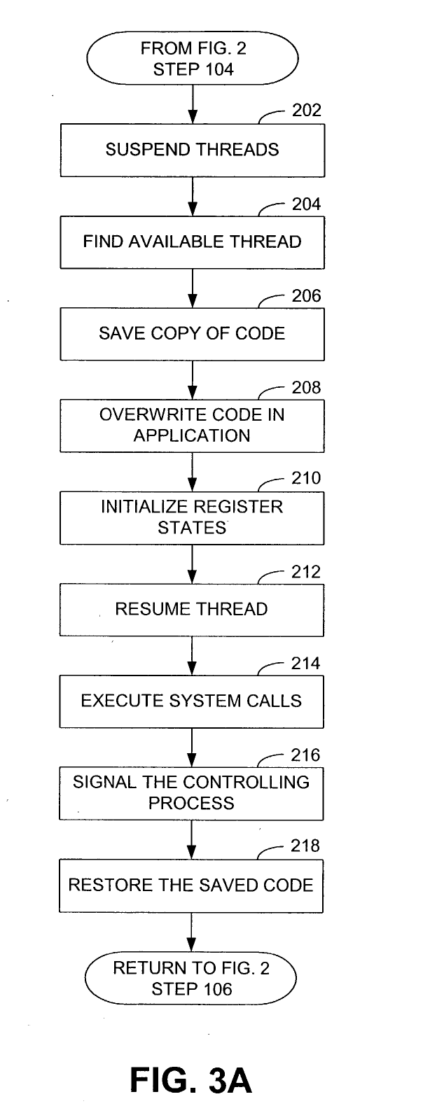

A process for performing dynamic instrumentation in accordance with one embodiment of the invention is depicted in FIG. 2. The process generally entails generating instrumented functions instead of the original functions in the application. Note that only those functions that are executed typically are instrumented. This can be is especially useful for instrumentation of large-scale applications.

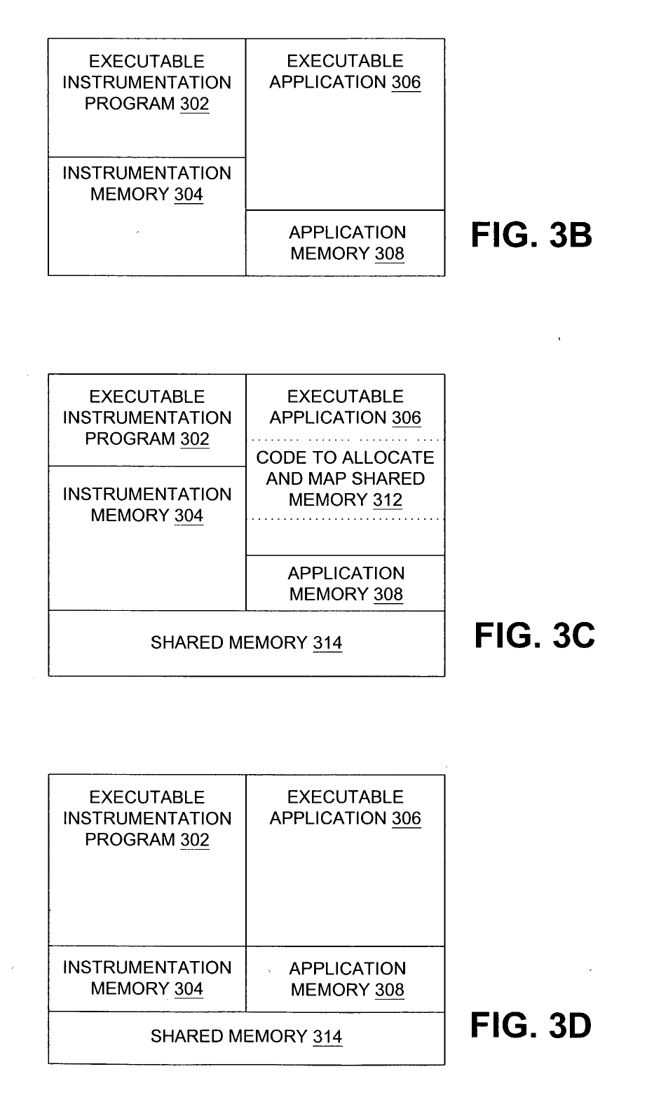

As shown in FIG. 2, the process 100 begins at step 102, an instrumentation process attaches to a target executable application and obtains control. Those skilled in the art should understand that this can be accomplished, for example, using known, conventional techniques. At step 104, the process allocates and maps shared memory for use by the instrumentation process and the executable application. The process of allocating and mapping the shared memory is described further in FIG. 3A.

At step 106, optional run-time libraries are added for dynamic instrumentation. These run-time libraries include, for example, code to dynamically increment the number of counters for indirect branch targets and code to perform a system call to register an instrumented function to the dynamic loader.

At step 108, entry points of the functions in the executable application are located. In addition to those methods that are known in the art, various other techniques for finding function entry points are described in the patent/application entitled, “ANALYSIS OF EXECUTABLE PROGRAM CODE USING COMPILER GENERATED FUNCTION ENTRY POINTS AND ENDPOINTS WITH OTHER SOURCES OF FUNCTION ENTRY POINTS AND ENDPOINTS”, to Hundt et al., having patent/application number *****, the contents of which is incorporated herein by reference.

Each of the function entry points is patched with a breakpoint at step 110. The instructions at the function entry points are saved in a table so that they can be restored at the appropriate time. At step 112, control is returned to the executable application.

When a breakpoint is encountered in the executable application, control is returned to the instrumentation process, and decision step 114 directs the process to step 118. At step 118 the executable is analyzed to find the function entry point for the break encountered, determine the length of the function, and analyze the function to identify target addresses of branch instructions (“branch targets”). For newly identified branch targets, the process is directed to step 122, where the branch targets are added to the list of function entry points, and the instruction at the branch target is patched with a break-point. The instruction at the branch target is first saved, however, for subsequent restoration. The process is then directed to step 124.

At step 124, a new instrumented function is generated and stored in the shared memory. The function of the executable application from which the new instrumented function is generated is that from which control was returned to the instrumentation process via the breakpoint (step 114). In generating the new instrumented function, the saved entry point instruction is restored as the first instruction of the new instrumented function in the shared memory. At step 126, the entry point instruction in the executable application is replaced with a long branch instruction having as a target the new instrumented function in the shared memory. The instrumentation process then continues at step 112, where control is returned to the executable application to execute the new instrumented function.

Returning now to step 120, if the branch target(s) identified at step 118 has already been instrumented, the branch target is replaced with the address in shared memory of the instrumented function (step 128). If the branch instruction is subsequently executed, control will jump to the instrumented function. The instrumentation process then continues at step 124 as described above.

For branch targets that have already been identified as functions, the process continues from step 120 directly to step 124.

Returning now to step 114, when the end of the executable application is reached, control is returned to the instrumentation process, and the instrumentation process continues at step 130. Selected instrumentation data that were gathered in executing the application are output at step 130 to complete the instrumentation process.

FIG. 3A is a flowchart of a process in accordance with one embodiment of the invention for allocating shared memory for an instrumentation process and application executable. FIGS. 3B-3D illustrate a sequence of memory states resulting from the process of allocating the shared memory depicted in FIG. 3A. Thus, references are made to the elements of FIGS. 3B-3D in the description of FIG. 3A.

Initially, the executable instrumentation program 302 (FIG. 3B) has a memory segment 308, and the application executable has memory segment 306. At step 202, all threads of the executable application are suspended. At step 204, an available thread is selected from the application. A thread is unavailable if it is in the midst of processing a system call. If no threads are available, then all the threads are restarted, and the application is allowed to continue to execute until one of the threads returns from a system call. When a thread returns from a system call, the threads are again suspended, and the available thread is selected.

At step 206, the process selects a segment of code within the executable application and saves a copy of the segment 310 in instrumentation memory 304. In addition, the states of registers of the application are saved in instrumentation memory segment 304.

At step 208, the selected segment of code in the application is overwritten with code segment 312 (“injected code”), which includes instructions to allocate and map shared memory (FIG. 3C). At step 210, the registers are initialized for use by the selected thread, and the beginning address of the code segment 312 is stored in the program counter. At step 212, the execution of the thread is resumed at the code segment 312.

In executing code segment 312, system calls are executed (step 214) to allocate the shared memory segment 314 and map the shared memory segment for use by the executable instrumentation program 302 and the executable application 306. A breakpoint at the end of the injected code 312 signals (step 216) the executable instrumentation program 302 that execution of the injected code is complete.

At step 218, the executable instrumentation program 302 restores the saved copy of code 310 to the executable application 302 (FIG. 3D) and restores the saved register values. The saved program counter is restored for the thread used to execute the injected code. Control is then returned to step 106 of FIG. 2.

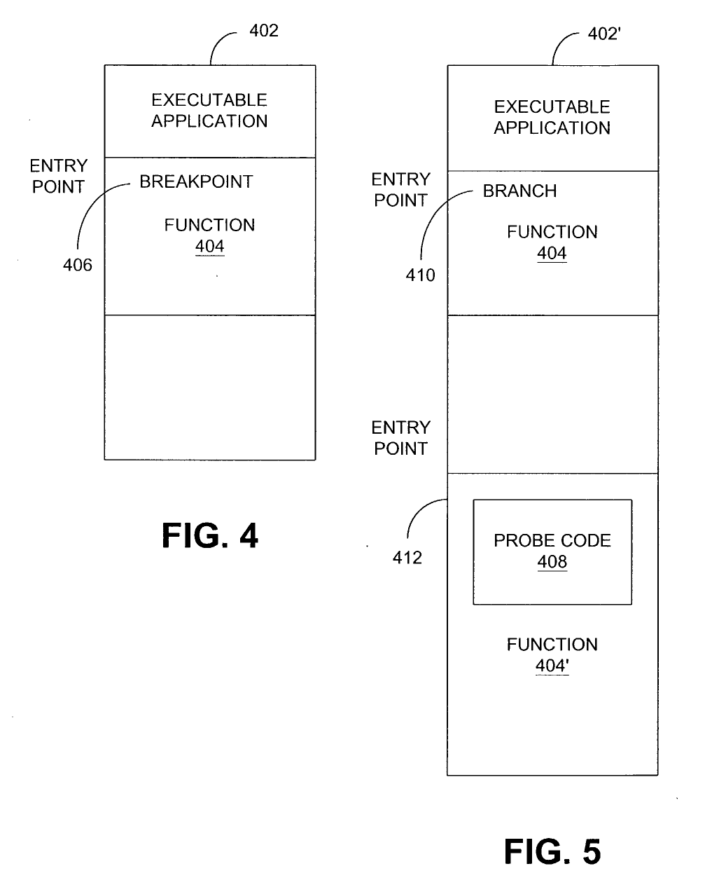

FIGS. 4 and 5 are block diagrams that illustrate the functional layout of memory used by an executable application during the instrumentation process. As shown and described in the process of FIG. 2 (step 108-110), the entry points of the functions in the executable application 402 are patched with breakpoints. For example, the entry point of function 404 is patched with breakpoint 406. When breakpoint 406 is encountered while executing the application 402, a new instrumented version of function 404 is generated (FIG. 2, steps 124 and 126).

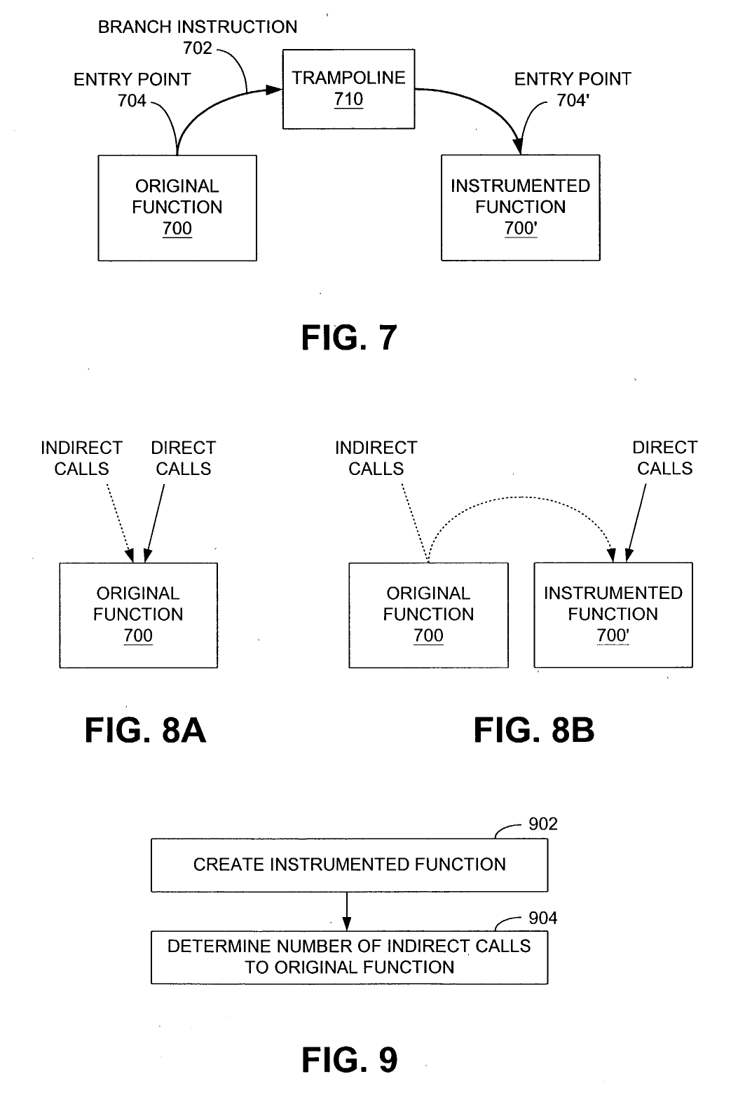

The new executable application 402′ (FIG. 5) includes the instrumented version of the function 404′, which is stored in the shared memory segment 314 (FIG. 3D). The instrumented function 404′ includes probe code 408, which, when executed within function 404′, generates selected instrumentation data. For example, the probe code 408 can count the number of times the function 404′ is executed. It should be understood that the program logic originally set forth in function 404 is preserved in function 404′. Note, the determination of type of call used to invoke function 404′ will be described later with respect to FIGS. 7 and 8.

In order to execute the instrumented function 404′, the instruction at the entry point of function 404 is replaced with a long branch instruction 401 having as a address the entry point 412 of instrumented function 404′. In addition, the addresses of branch instructions elsewhere in the application 402′ that target function 404 are changed to reference instrumented function 404′.

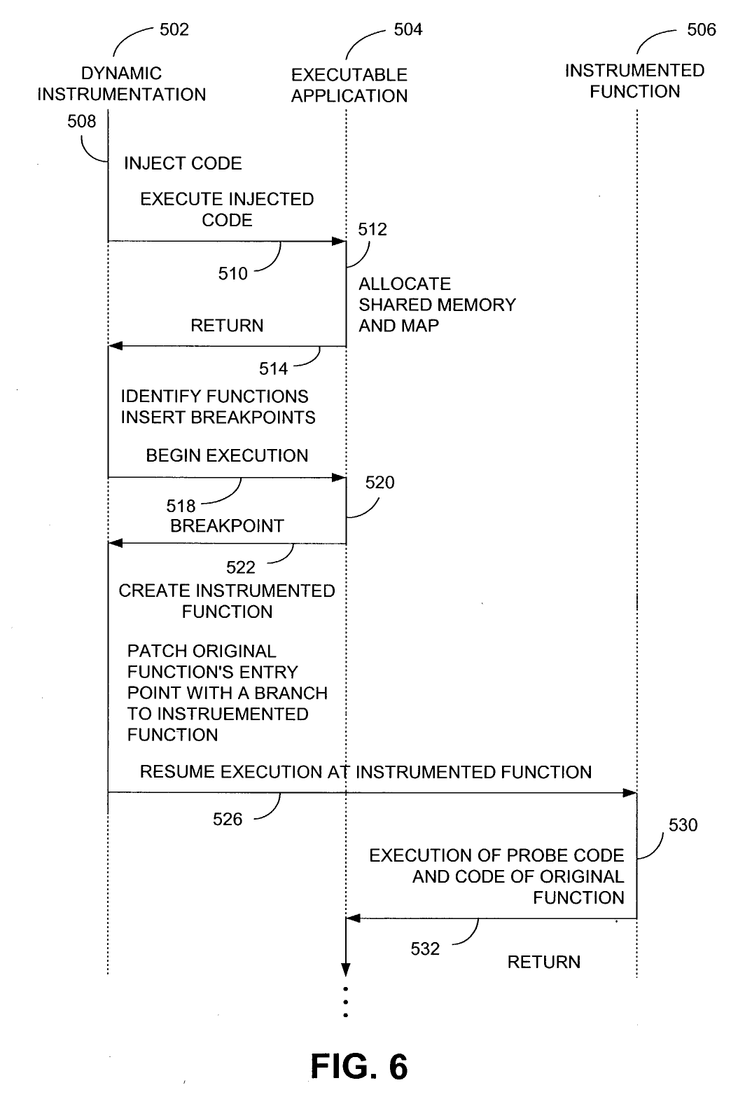

FIG. 6 is a flow diagram that illustrates the interaction between the process that controls dynamic instrumentation 502, the executable application 504, and the instrumented function 506. The vertical portions of the directional lines represent execution of code indicated by the respective headers above the lines. The horizontal portions indicate a transfer of control from one set of code to another set of code.

The control flow begins with the dynamic instrumentation code injecting code (508) into the executable application 504 (e.g., FIG. 3C). Control is transferred (510) from the dynamic instrumentation code to the executable application code to execute the injected code. The executable application 504 allocates and maps (512) shared memory for use by the dynamic instrumentation and the executable application.

Control returns (514) to the dynamic instrumentation code, which then identifies functions in the executable application 504 and inserts breakpoints (516). Control is then transferred (518) to the executable application, which executes the application code (520) until a breakpoint is reached. The breakpoint indicates the beginning of a function. The breakpoint transfers control (522) back to the dynamic instrumentation code, and the dynamic instrumentation code creates an instrumented version of the function (FIG. 5) and patches the original function entry point with a branch to the instrumented function. Execution of the application 504 is then resumed (526) at the instrumented function 506.

The code of the instrumented function along with the probe code (FIG. 5, 408) is executed (530). Control is eventually returned (532) to execute other code in the application. The process then continues as described above with reference to FIG. 2.

As mentioned before, embodiments of the present invention enable the type of call used to invoke a function to be determined. In this regard, reference is made to FIG. 7, which is schematic diagram depicting an original function 700, a related instrumented function 700′ and a branching instruction 702 that is used to patch function 700's entry point 704 with the entry point 704′ of the instrumented function. Note that instead of directing calls from entry point 704 to 704′ directly, the branching instruction directs calls to a trampoline 710, which then directs the calls to the entry point 704′ of the instrumented function. Preferably, the trampoline increments a counter each time a call is passed. Thus, information of the counter corresponds to the number of indirect calls used to invoke the function.

In particular, since the dynamic instrumentation process described above causes direct calls that target the original function 700 to be directed to the entry point 704′ of the instrumented function 700′ as direct calls, only those calls that are directed to the original function as indirect calls should use the original function entry point 704 after instrumentation. Therefore, by determining the number of calls directed to the original function entry point after instrumentation has taken place, the number of calls routed to the instrumented function entry point via the branching instruction corresponds to the number of indirect calls used to invoke the original function.

Reference is now made to the schematic diagrams of FIGS. 8A and 8B, which depict the operation of direct and indirect calls before and after instrumentation, respectively. As shown in FIG. 8A, original function 700 includes an entry point that receives both indirect and direct calls. After instrumentation, as depicted in FIG. 8B, direct calls to the original function 700 are now directed to the instrumented function 700′ as direct calls. This is because instrumentation replaces the target addresses of the branch instructions that reference the original function with target addresses that reference the instrumented function 700′. Note, however, that indirect calls still are directed to the entry point of the original function. Branch instruction 702 is used to route the indirect calls arriving at the entry point of the original function to the entry point of the instrumented function. Calls utilizing the branching instruction for routing from the entry point of the original function to the entry point of the instrumented function can then be counted.

A process in accordance with one embodiment of the invention for determining the number of indirect calls used to invoke a function is depicted in FIG. 9. As shown in FIG. 9, the process begins at step 902, where an instrumented function corresponding to an original function is created. At step 904, the number of calls directed to the entry point of the original function after the instrumented function is created, is determined. As mentioned before, the calls using the entry point of the original function after instrumentation has been performed are indirect calls.

It should be emphasized that the above-described embodiments of the present invention are merely possible examples of implementations set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims, except to the extent limited by the prior art.

What is claimed is:

1. A computer-implemented method for dynamic instrumentation of an application program, the application program including a plurality of original functions, each original function having an entry point, said method comprising:
creating substitute functions corresponding to the original functions in the application program;
executing the substitute functions in lieu of the original functions in the application program; and
determining the number of indirect calls made to the respective entry points of the original functions.

2. The method of claim 1, further comprising:
modifying the respective entry points of the original functions in the application program with branch instructions that target the substitute functions.

3. The method of claim 2, wherein determining the number of indirect calls comprises determining the number of calls routed to the respective substitute functions via the respective entry points of the original functions.

4. The method of claim 1, further comprising:
using trampoline code to determine the number of indirect calls made to the respective entry points of the original functions.

5. The method of claim 4, further comprising:
modifying the entry point of one of the original functions in the application program with a first branch instruction; and
incrementing a counter when the first branch instruction is used to route a call to the substitute function corresponding to the one of the original functions.

6. A dynamic instrumentation system for performing dynamic instrumentation of an application program, the application program including a plurality of original functions, each original function having an entry point, said system comprising:
means for creating substitute functions corresponding to the original functions in the application program;
means for executing the substitute functions in lieu of the original functions in the application program; and
means for determining the number of indirect calls made to the respective entry points of the original functions.

7. The system of claim 6, further comprising:
means for modifying the respective entry points of the original functions in the application program with branch instructions that target the substitute functions.

8. The system of claim 7, wherein said means for determining the number of indirect calls comprises means for determining the number of calls routed to the respective substitute functions via the respective entry points of the original functions.

9. The system of claim 6, further comprising:
a counter operative to record the number of calls using the first branch instruction for routing to the substitute function corresponding to the one of the original functions.

10. The system of claim 9, further comprising:
means for modifying the entry point of one of the original functions in the application program with a first branch instruction; and
means for incrementing the counter when the first branch instruction is used to route a call to the substitute function corresponding to the one of the original functions.

11. A dynamic instrumentation system for performing dynamic instrumentation of an application program, the application program including a plurality of original functions, each original function having an entry point, said system comprising:
logic configured to create substitute functions corresponding to the original functions in the application program;
logic configured to execute the substitute functions in lieu of the original functions in the application program; and
logic configured to determine the number of indirect calls made to the respective entry points of the original functions.

12. The system of claim 11, further comprising:
logic configured to modify the respective entry points of the original functions in the application program with branch instructions that target the substitute functions.

13. The system of claim 12, wherein said logic configured to determine the number of indirect calls comprises logic configured to determine the number of calls routed to the respective substitute functions via the respective entry points of the original functions.

14. The system of claim 11, further comprising:
a counter operative to record the number of calls using the first branch instruction for routing to the substitute function corresponding to the one of the original functions.

15. The system of claim 14, further comprising:
logic configured to modify the entry point of one of the original functions in the application program with a first branch instruction; and
logic configured to increment the counter when the first branch instruction is used to route a call to the substitute function corresponding to the one of the original functions.
